(19) United States
(12) Patent Application Publication
(10) Pub. No.: US 2006/0005169 A1
(43) Pub. Date: Jan. 5, 2006

(54) Software development system and method

(75) Inventors: Viktors Berstis, Austin, TX (US); Xiaolin Li, Edison, NJ (US); Scott Michael Preddy, Austin, TX (US); Lan B. Tran, Milpitas, CA (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/881,970

(22) Filed: Jun. 30, 2004

(51) Int. Cl. G06F 9/44

(52) U.S. Cl. 717/125

(57) ABSTRACT

The present invention provides for a method for software development. A first computer program code written in a programming language is received for analysis. The first computer program code is analyzed for at least a programming error. If at least one programming error is found, correction suggestions are generated based on the detected programming error. The correction suggestions are displayed to a user for input from the user. The first computer program code is modified in response to the user input.

### TECHNICAL FIELD

The present invention relates generally to the field of computer programming and, more particularly, to improving efficiency in identifying and correcting programming errors.

### BACKGROUND

Computer programs-series of instructions, or “program code,” directing a computer or other device to perform specific tasks-are written in one of many programming languages. Programming languages include, for example, Java, JavaScript, C++, Perl, and various other languages. Programming languages often include a syntax and grammar that must be followed in order for the resultant program to perform the functions and tasks intended by the programmer writing the program. Moreover, in many programming languages, the program code and the tasks the code performs must be logically consistent.

Code that fails to comply with the syntax and/or grammar rules of the programming language, or code that is logically inconsistent, can result in instructions to the target device that are unclear, indefinite, or inconsistent. These deficient instructions can cause errors that can disrupt the proper functioning of the program, cause the program to terminate unexpectedly or yield erroneous results, cause cascading errors in the system on which the program is running, or cause other effects not intended by the programmer.

Therefore, in order to produce reliable programs, programmers, or others associated with developing computer programs, often verify that each line of code complies with the particular programming language's syntax and grammar and is logically consistent. Because modern programs often comprise thousands of lines of instructions, the verification process can be burdensome. As a result, certain systems were developed to automate to some extent the verification process by identifying possible coding errors. These systems, however, often fail to do more than identify certain errors, which does little to reduce the time a programmer spends to correct the errors. In a lengthy segment of code, the time a programmer spends correcting errors identified by such a review system can outweigh the time it would have taken the programmer to review and correct the code simultaneously.

Therefore, there is a need for a method and/or system for software development that addresses at least some of the problems and disadvantages associated with conventional systems and methods.

### SUMMARY

The present invention provides for a method for software development. A first computer program code written in a programming language is received for analysis. The first computer program code is analyzed for at least a programming error. If at least one programming error is found, correction suggestions are generated based on the detected programming error. The correction suggestions are displayed to a user for input from the user. The first computer program code is modified in response to the user input.

### BRIEF DESCRIPTION OF THE DRAWINGS

For a more complete understanding of the present invention and the advantages thereof, reference is now made to the following descriptions taken in conjunction with the accompanying drawings, in which like reference numerals identify similar elements, and in which:

FIG. 1 is a block diagram depicting a software development system; and

FIG. 2 is a flow diagram depicting a software development method.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or in some combinations thereof. In a preferred embodiment, however, the functions are performed by a processor such as a computer or an electronic data processor in accordance with code such as computer program code, software, and/or integrated circuits that are coded to perform such functions, unless indicated otherwise.

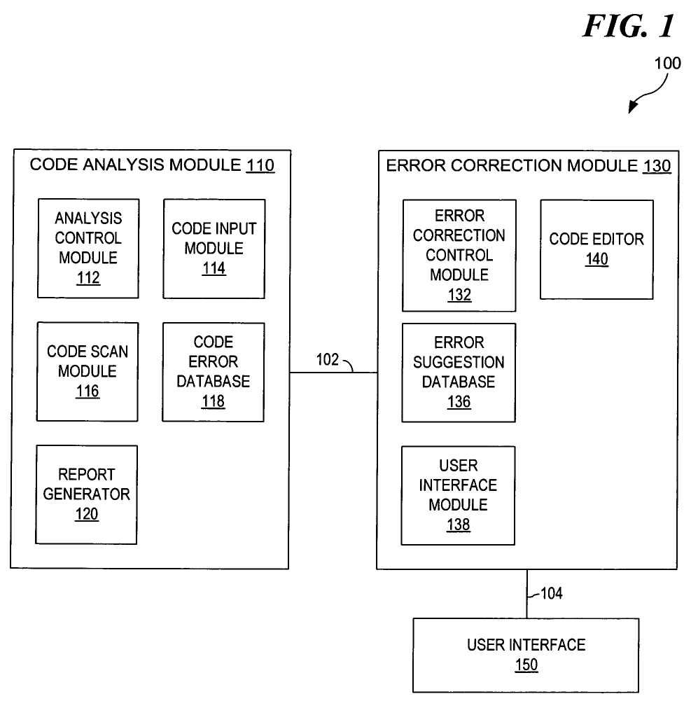

Referring to FIG. 1, the reference numeral 100 generally designates a Software Development System. Generally, in operation, Software Development System 100 receives and analyzes code for programming errors and presents suggestions to correct the programming errors to a user. Programming errors include, for example, Null Pointer Exceptions, International Integration Errors, and New Line Errors. It will be understood to one skilled in the art that Software Development System 100 can also be configured to address other programming errors.

Generally, a Null Pointer Exception is a programming error wherein it is unclear whether a reference pointer has been set to a value or is in a null state. In Java in particular, a pointer is a reference that is expected to be guaranteed not to be null. For example, a Null Pointer Exception can appear in code as:

public void setBounds (Rectangle inR)
{

super.setBounds (inR);

}

One option to correct a Null Pointer Exception can be, for example:

public void setBounds (Rectangle inR)
{

if (inR == null)
{

return;

}
super.setBounds (inR);

}

Several other options are also available to correct a Null Pointer Exception. The programmer can indicate what the program should do in the event the pointer is in a null state at runtime and can include many different runtime solutions, including instructions to display an error message, to perform a specific task to ensure the pointer is no longer in a null state, to ignore the “if” statement altogether (for example, with an appropriately modified “else” statement), to quit the program, or other suitable solution. Therefore, suitable suggestions to correct a Null Pointer Exception at test time include automatically modifying the code to include an “if (pointer !=null)” correction, a suitable runtime solution, or other suitable suggestions for correcting the Null Pointer Exception.

Generally, an International Integration Error is a programming error wherein certain spoken-language-specific words or code are included in a general-purpose code segment designed to be used in programs supporting use in multiple spoken languages. For example, an International Integration Error can appear in code as:

} catch (RuntimeException e)
{

System.out.println (“LinkRouter:handleCollision:

”.concat (e.toString( )));

}

One option to correct an International Integration Error can be, for example:

} catch (RuntimeException e)
{

System.out.println(Messages.getstring(“LinkRouter.LinkRouter
_handleCollision_1”).concat(e.toString( ))); //$NON-NLS-1$

}

Thus, correcting an International Integration Error typically requires modifying the offending programming code to remove the language-specific words or language-specific code to a language-specific code segment. This can also require modifying code not currently being tested, as in the case where the tested code is designed to be language-neutral and relies on other language-specific code to be implemented in a particular spoken language. It will be understood to one skilled in the art that other suitable corrections can also be employed. Therefore, suitable suggestions to correct an International Integration Error include modifying the programming code under review to remove the language-specific words and modifying a separate programming code segment to account for the changes in the programming code under review, or other suitable corrections.

Generally, a New Line Error is a programming error wherein the code at runtime would write two (or more) consecutive print statements, resulting in a new line after each print statement. For example, a New Line Error can appear in code as:

public CompartmentFigure ( )
{

System.out.println (“Entering

Constructcr.\nInitializing data members.”);

}

One option to correct a New Line Error can be, for example:

public CompartmentFigure ( )
{

System.out.println (“Entering Constructor.”);

//$NON-NLS-1$

System.out.println (“Initializing data members.”);

//$NON-NLS-1$

}

Several other options are also available to correct a New Line Error, including ignoring the New Line Error, concatenating the two or more print statements, separating the two or more print statements, or other suitable correction. Therefore, suitable suggestions to correct a New Line Error include automatically inserting a comma after the first (or other) print statement(s), concatenating the two or more print statements into one print statement, ignoring the error, separating the two or more print statements, or other suitable corrections.

Referring to FIG. 1, Software Development System 100 comprises a Code Analysis Module 110, an Error Correction Module 130, and a User Interface 150. In the illustrated embodiment, Code Analysis Module 110 is coupled to Error Correction Module 130 and Error Correction Module 130 is coupled to User Interface 150. In other embodiments, User Interface 150 can be coupled to both Code Analysis Module 110 and Error Correction Module 130, or User Interface 150 can be coupled solely to Code Analysis Module 110. In other embodiments, one or more of the elements of Code Analysis Module 110 and Error Correction Module 130 can be combined into a single module. In the illustrated embodiment, Code Analysis Module 110 is coupled to Error Correction Module 130 through a first communication channel 102 and Error Correction Module 130 is coupled to User Interface 150 through a second communication channel 104.

Code Analysis Module 110 comprises Analysis Control Module 112, Code Input Module 114, Code Scan Module 116, Code Error Database 118, and Report Generator 120. Analysis Control Module 112 is configured to communicate with and direct the actions of Code Input Module 114, Code Scan Module 116, Code Error Database 118, and Report Generator 120. Analysis Control Module 112 is also configured to communicate with Error Correction Module 130. In an embodiment where User Interface 150 is coupled to Code Analysis Module 110, Analysis Control Module 112 is also configured to communicate with User Interface 150.

Code Input Module 114 is configured to receive and store code to be analyzed by Software Development System 100, to communicate with Code Scan Module 116, and to receive commands from Analysis Control Module 112. Code Scan Module 116 is configured to communicate with Code Input Module 114 and Code Error Database 118, to receive error rules for analyzing code from Code Error Database 118, to receive and analyze code retrieved or received from Code Input Module 114 based on error rules received from Code Error Database 118, and to receive commands from Analysis Control Module 112.

Code Error Database 118 is configured to store information or data relating to the specific errors Software Development System 100 is used to detect, based on a predetermined set of errors, user input designating specific errors, or other suitable input. Code Error Database 118 is also configured to generate error rules based on stored information or data relating to specific errors Software Development System 100 is used to detect, to communicate with Code Scan Module 116, to transmit error rules to Code Scan Module 116, and to communicate with Analysis Control Module 112.

Report Generator 120 is configured to communicate with Analysis Control Module 112, to receive commands and data from Analysis Control Module 112, and to generate a report based on the received commands and data.

In operation, Code Analysis Module 110 is initialized, as described in more detail below, and Analysis Control Module 112 directs Code Input Module 114 to receive code to be analyzed based on user, predetermined, or other suitable input. Analysis Control Module 112 directs Code Error Database 118 to generate error rules based on user, predetermined, or other suitable input, previously stored information or data relating to specific errors Software Development System 100 is used to detect, predetermined error rules, or other suitable bases. Analysis Control Module 112 directs Code Error Database 118 to transmit the error rules to Code Scan Module 116. Analysis Control Module 112 then directs Code Input Module 114 to transmit a section of the code to be analyzed to Code Scan Module 116.

Code Scan Module 116 analyzes the code received from Code Input Module 114 based on the error rules received from Code Error Database 118. If no programming error is found, Code Scan Module 116 transmits this information to Analysis Control Module 112, and Analysis Control Module 112 directs Code Input Module 114 to transmit another section of the code to be analyzed to Code Scan Module 116. In ordinary operation, the sections of the code to be analyzed are analyzed in sequence beginning with the first line of code. In other embodiments, Analysis Control Module 112 can direct Code Input Module 114 to skip certain (-ode segments, begin a sequential analysis at a specific code segment or line number, or other suitable sequence based on user, predetermined, or other suitable input.

If Code Scan Module 116 detects a programming error, Code Scan Module 116 transmits information relating to the particular programming error to Analysis Control Module 112. The transmitted information can include the error rule the code violates, the specific line number of the code in relation to the entire code to be analyzed, and/or other suitable information. Analysis Control Module 112 transmits code error information to Error Correction Module 130 based on the information received from Code Scan Module 116. Error Correction Module 130 performs tasks based on the information received from Analysis Control Module 112, as described in more detail below, and transmits correction information to Analysis Control Module 112. Analysis Control Module 112 directs Report Generator 120 to generate a change report based on the correction information received from Error Correction Module 130. Analysis Control Module 112 also directs Code Input Module 114 to modify the stored code based on the correction information received from Error Correction Module 130, and to transmit the modified code to Code Scan Module 116 for analysis.

Analysis Control Module 112 continues to operate as described above, directing Report Generator 120 to append or suitably modify the change report as correction information is received from Error Correction Module 130, until all of the code to be analyzed has been processed. In other embodiments, Analysis Control Module 112 can direct Report Generator 120 to produce a change report after all of the code to be analyzed has been processed.

Software Development System 100 also comprises Error Correction Module 130. Error Correction Module 130 is coupled to Code Analysis Module 110 and is configured to receive code error information from Code Analysis Module 110, generate correction information based on received code error information, and transmit correction information to Code Analysis Module 110. Error Correction Module 130 comprises Error Correction Control Module 132, Error Suggestion Database 136, User Interface Module 138, and Code Editor 140.

Error Correction Control Module 132 is configured to communicate with and direct the operations of Error Suggestion Database 136, User Interface Module 138, and Code Editor 140. Error Correction Control Module 132 is also configured to communicate with Code Analysis Module 110. Error Suggestion Database 136 is configured to communicate with Error Correction Control Module 132, to receive code error information from Error Correction Control Module 132, to generate suggestion information based on code error information received from Error Correction Control Module 132, and to transmit suggestion information to Error Correction Control Module 132.

User Interface Module 138 is configured to communicate with Error Correction Control Module 132 and User Interface 150, to receive code error information and suggestion information from Error Correction Control Module 132, to transmit code error information and suggestion information to User Interface 150, to receive user response information from User Interface 150, and to transmit received user response information to Error Correction Control Module 132.

Code Editor 140 is configured to communicate with Error Correction Control Module 132 and User Interface 150, to receive error information and suggestion information from Error Correction Control Module 132, to transmit error information and suggestion information to User Interface 150, to receive user response information from User Interface 150, and to transmit received user response information to Error Correction Control Module 132. Code Editor 140 is configured to modify the subject code based on accepted suggestion information from Error Correction Control Module 132 and user response information from User Interface 150.

In operation, when code error information is received, Error Correction Control Module 132 retrieves suggestion information from Error Suggestion Database 136 and passes the suggestion information and code error information to User Interface Module 138. User Interface Module 138, through User Interface 150, alerts a user that a programming error has been detected, displays a portion of the code, typically including code surrounding the offending code, and presents the user with suggestions to correct the code. For example, when Code Analysis Module 110 detects a Null Pointer Exception, Error Correction Module 130 receives code error information, as described above. User Interface Module 138 alerts the user that a Null Pointer Exception error has been detected, displays code segments preceding, following and including the code in which the Null Pointer Exception error was detected, and offers suggestions for correcting the code based on the suggestion information received from Error Correction Control Module 132. The user can evaluate the code presented and accept one of the suggestions, reject the suggestions in favor of a correction not suggested, or elect to ignore the error and correct it at a later time. It will be understood to one skilled in the art that other options can also be available to the user.

In an alternative embodiment, Error Correction Control Module 132 offers suggestions that require some user input, such as, for example, the name of a variable or subroutine. If the user accepts an offered suggestion, User Interface Module 138 passes the accepted suggestion and any associated user input to Error Correction Control Module 132, which directs Code Editor 140 to edit the code to conform to the accepted suggestion.

If the user instead elects to correct the code with a correction not suggested, User Interface Module 138 passes this information to Error Correction Control Module 132, which directs Code Editor 140 to interact with the user through User Interface 150. In particular, Code Editor 140 can open one or more graphical user interfaces (GUIs) displaying the relevant code segments and allowing the user to make changes to the code. Certain errors, such as International Integration Errors for example, often require that one or more additional programs be modified in addition to the code currently being evaluated. Thus, Code Editor 140 can open one or more discrete GUIs to allow the user to make changes to related or other programs.

When the user has completed the desired changes, Code Editor 140 passes the corrections to Error Correction Control Module 132, which generates and transmits correction information to Code Analysis Module 110. Code Analysis Module 110 processes the correction information as described above.

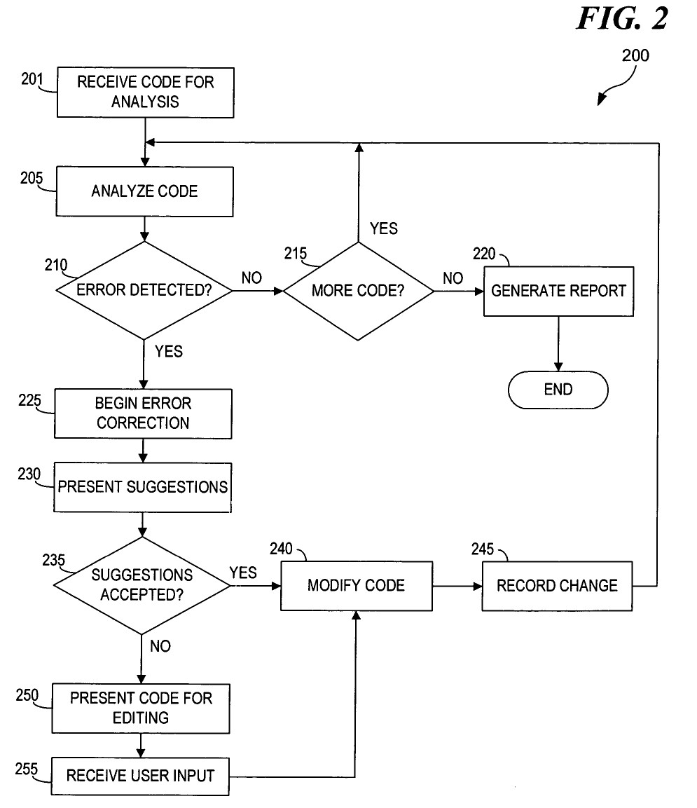

Referring to FIG. 2 of the drawings, the reference numeral 200 generally designates a flow chart depicting the operation of a software development system. The process begins at step 201, wherein computer program code is received for analysis. This step is performed by Code Input Module 114 of FIG. 1. In step 205, the received computer program code is analyzed to detect at least one of a plurality of predetermined programming errors. This step is performed by Code Scan Module 116 of FIG. 1, as described above.

In a particular embodiment, a line of code is analyzed. As used herein, a “line of code” includes a single line, a group of lines making up a single command, or a group of commands making up a single statement. It will be understood to one skilled in the art that other suitable groupings can also be analyzed. In the illustrated embodiment, programming errors include Null Pointer Exception errors, International Integration Errors, and New Line Errors. It will be understood to one skilled in the art that other errors can also be detected.

In decisional step 210, a determination is made whether the line of code contains a programming error. This step is performed by Code Scan Module 116 based on input from Code Error Database 118, as described above. If in decisional step 210 a programming error is detected, the process continues along the YES branch to step 225. In step 225, Error Correction begins. This step is performed by Error Correction Module 130 of FIG. 1. This step includes generating suggestions based on the detected programming error, performed by Error Suggestion Database 136 of FIG. 1.

In step 230, the suggestions are presented to a user for input. This step is performed by User Interface Module 138 and User Interface 150 of FIG. 1 based on the suggestions generated in step 225. As described above, one or more suggestions can include suggestions requiring user input, such as a variable name, subroutine name, or other suitable input. In decisional step 235, a determination is made whether one or more of the suggestions have been accepted by the user based on user input. This step is performed by User Interface Module 138 of FIG. 1.

If in decisional step 235 none of the suggestions have been accepted by the user, the process continues along the NO branch to step 250. In step 250, the relevant lines of code are presented to the user for editing. This step is performed by Code Editor 140 and User Interface 150 of FIG. 1, as described above. In the illustrated embodiment, the user is also presented with lines of code surrounding the code at issue and a standard correction pre-typed into the code, in order to assist in error correction and for ease of use. As described above, Code Editor 140 can provide one or more graphical user interfaces (GUIs) in situations where the line of code is edited in more than one program file, such as, for example, to correct an International Integration Error, or in other suitable situations.

In step 255, user input is received. This step is performed by User Interface 150 and Code Editor 140 of FIG. 1. As described above, the user input can include user edits to the line of code at issue and any other lines of code modified by the user. Code Editor 140 generates correction information for the code based on the user input. The process continues to step 240, wherein the code is modified based on the received user input.

If in decisional step 235 one or more of the suggestions have been accepted by the user, the process continues along the YES branch to step 240. In step 240, the line of code is modified based on user input. This step is performed by User Interface Module 138, Error Correction Control Module 132, and Code Editor 140 of FIG. 1, as described above. If the user input constitutes accepting a suggestion presented in step 230, the line of code id modified according to the suggested correction. If the user input constitutes user edits received in step 255, the line of code (and any other code modified by the user) is modified according to the user edits. In an alternate embodiment, the relevant lines of code are presented to the user for editing, regardless of whether the user has accepted one or more suggestions. If the user has accepted one or more suggestions, the relevant lines of code are presented as modified in accordance with the accepted suggestions. If the user has not accepted one or more suggestions, the relevant lines of code are presented unmodified.

In step 245, the programming errors detected and the changes made to the code at issue and other code presented to the user, if any, are recorded. This step is performed by Error Correction Control Module 132 of FIG. 1. The process returns to step 205, wherein the modified code is analyzed to determine whether errors are present in the modified code. In the illustrated embodiment, only the modified code at issue is analyzed when the process returns to step 205. In an alternate embodiment, any other modified code, such as, for example, other program code modified to correct an International Integration Error, can also be analyzed.

If in decisional step 210 no programming error is detected, the process continues along the NO branch to decisional step 215. In decisional step 215, a determination is made whether there are more lines of code to analyze. This step is performed by Analysis Control Module 112 of FIG. 1, as described above. If in decisional step 215 there are additional lines of code to be analyzed, the process continues along the YES branch, returning to step 205.

If in decisional step 215 there are no more lines of code to be analyzed, the process continues along the NO branch to step 220. In step 220, a report is generated based on programming errors detected and/or corrected during the process, if any, and the process ends. This step is performed by Report Generator 120 of FIG. 1, as described above, based on the programming errors and/or changes to the code recorded in step 245, if any, as described above. In the illustrated embodiment, a report is generated after all of the code at issue is analyzed. In an alternate embodiment, a report can be generated after each error is detected and/or corrected. That is, the process can proceed from step 245 to step 220, and then to step 205. In an alternate embodiment, a report can be generated after the first programming error is detected and/or corrected, and the report can be amended to include subsequent additional programming errors detected and/or corrected, if any.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for software development, comprising:
receiving a first computer program code written in a programming language for analysis;
analyzing the first computer program code for at least a programming error;
if at least one programming error is found, generating correction suggestions based on the detected programming error;
displaying the correction suggestions to a user for input from the user; and
modifying the first computer program code in response to the user input.

2. The method as recited in claim 1, wherein the programming language is JAVA.

3. The method as recited in claim 1, wherein the programming language is C++.

4. The method as recited in claim 1, wherein the programming error is a Null Pointer Exception.

5. The method as recited in claim 1, wherein the programming error is an International Integration Error.

6. The method as recited in claim 1, wherein the programming error is a New Line Error.

7. The method as recited in claim 1, further comprising generating a report based on the user input and the detected programming error.

8. The method as recited in claim 1, further comprising presenting the computer program code in a first code editor to a user for input from the user.

9. The method as recited in claim 8, further comprising:
modifying the computer program code to incorporate the correction suggestions; and
presenting the modified computer program code to the user in the first code editor.

10. The method as recited in claim 8, further comprising presenting a second computer program code in a second code editor to the user for a second input from the user, the second input based on the second computer program code.

11. A system for software development, comprising:
a processor configured to receive and analyze computer program code written in a programming language, detect programming errors in the computer program code, receive correction suggestions from a database based on detected programming errors, and modify the computer program code based on input from a user;
a database coupled to the processor and configured to store error correction suggestions and transmit error correction suggestions to the processor; and
an interface coupled to the processor and configured to present the computer program code and error correction suggestions to the user and to receive user input.

12. The system as recited in claim 11, wherein the processor is further configured to generate a report based on the user input and detected programming errors.

13. The system as recited in claim 11, wherein the programming error is one of a group of programming errors comprising a Null Pointer Exception, an International Integration Error, and a New Line Error.

14. The system as recited in claim 11, further comprising a code editor coupled to the processor and the interface and configured to present program code and correction suggestions to a user for editing.

15. A computer program product for software development, the computer program product having a medium with a computer program embodied thereon, the computer program comprising:
computer program code for receiving a first computer program code written in a programming language for analysis;
computer program code for analyzing the first computer program code for at least a programming error;
computer program code for detecting a programming error;
computer program code for generating correction suggestions based on the detected programming error;
computer program code for displaying the correction suggestions to a user for input from the user; and
computer program code for modifying the first computer program code in response to the user input.

16. The computer program product as recited in claim 15, further comprising computer program code for generating a report based on the user input and the detected programming error.

17. The computer program product as recited in claim 15, further comprising computer program code for presenting the first computer program code in a first code editor to a user for input from the user.

18. A method for automated J-test null pointer deficiency repair, comprising:
executing a J-test on code to generate a least a defect notice of possible usage of null pointers for a code segment; and
automatically generating in response to said defect notice an IF statement around the code segment of the form “if(var !=null)”.

19. The method as recited in claim 18, further comprising:
presenting the code segment to a user for user input; and
modifying the code segment based on received user input.

20. The method as recited in claim 18, further comprising generating a report based on the defect notice.
